(19) United States
(12) Patent Application Publication
(10) Pub. No.: US 2016/0073828 A1
(43) Pub. Date: Mar. 17, 2016

(54) Culinary Grater

(71) Applicants: Emilie Leman, Denver, CO (US); Justin Brown, Pittsburg, KS (US)

(72) Inventors: Emilie Leman, Denver, CO (US); Justin Brown, Pittsburg, KS (US)

(21) Appl. No.: 14/857,473

(22) Filed: Sep. 17, 2015

Related U.S. Application Data
(60) Provisional application No. 62/051,321, filed on Sep. 17, 2014.
(60) Provisional application No. 62/081,071, filed on Nov. 18, 2014.

(51) Int. Cl. A47J 43/25

(52) U.S. Cl. CPC A47J 43/25

(57) ABSTRACT

A culinary grater has a body rotatably attached to a handle. A detent mechanism is located between a fitting on the body and a head piece, part of the handle. The detent is spring biased and prevents rotation when the head piece engages the fitting under the biasing action of the spring. The culinary grater also has a grating surface with projections having cutting edges. The cutting edges of the projections face in opposite directions, allowing the grater to grate matter when the grater is applied to foodstuff in either a pushing or pulling motion.

### CROSS-REFERENCE TO RELATED APPLICATIONS

This application claims the benefit of and priority to U.S. Provisional Patent Application Ser. No. 62/051,321, filed Sep. 17, 2014, and U.S. Provisional Application Ser. No. 62/081,071, filed Nov. 18, 2014, each of which is incorporated by reference herein in its entirety.

### FIELD OF THE INVENTION

This invention relates to grating devices, in particular, graters for culinary use.

### BACKGROUND

Graters have long been used on foodstuffs such as cheeses, vegetables and the like to render the foodstuffs from one form to another. It is, for example, well known to grate cheese into granular or sliver form for convenient application to a main course, as well as to grate cabbage, lettuce, carrots, potatoes and other vegetables as called for by various recipes. As hand grating of foodstuffs may be considered an onerous, but necessary, task in food preparation, there is clearly a need for a grating device that falls well to the hand, grates foodstuff when applied to foodstuff with a pushing or pulling motion, and is convenient to use in varied situations and on various different foodstuffs.

### SUMMARY

Disclosed herein, in various embodiments, are devices and methods for grating foodstuffs.

In exemplary embodiments, disclosed herein is a grater. In one aspect, the grater comprises a body surrounding a central space, the body having a first end, the body comprising at least one grating surface, the at least one grating surface comprising a plurality of openings communicating with the central space, at least a portion of the openings each having an associated projection extending outwardly from the grating surface away from the central space. In another aspect, the grater comprises a fitting mounted on and closing the first end of the body. In a further aspect, the grater comprises a handle having a grip attached to a head piece, the head piece being rotatably attached to the fitting, thereby permitting the body and the handle to rotate relatively to one another.

### BRIEF DESCRIPTION OF THE DRAWINGS

FIG. 1 is an isometric view of an example embodiment of a grater according to the invention;

FIG. 2 is a perspective exploded view of the grater shown in FIG. 1;

FIG. 3 is a plan view of a portion of the grater shown in FIG. 1;

FIG. 4 is a sectional view of the portion of the grater shown in FIG. 3;

FIG. 5 is a longitudinal sectional view of a portion of the grater shown in FIG. 1;

FIG. 6A is a front view of an example embodiment of a grater according to the invention. FIG. 6B is an exploded view of a portion of the grater shown in FIG. 6A;

FIG. 7 is an isometric view of a portion of an example embodiment of a grater according to the invention;

FIG. 8 is a sectional view of the portion of the grater shown in FIG. 7, taken along line 8-8;

FIG. 9 is an isometric view of a portion of an example embodiment of a grater according to the invention; and

FIG. 10 is a sectional view of the portion of the grater shown in FIG. 9, taken along line 10-10.

### DETAILED DESCRIPTION

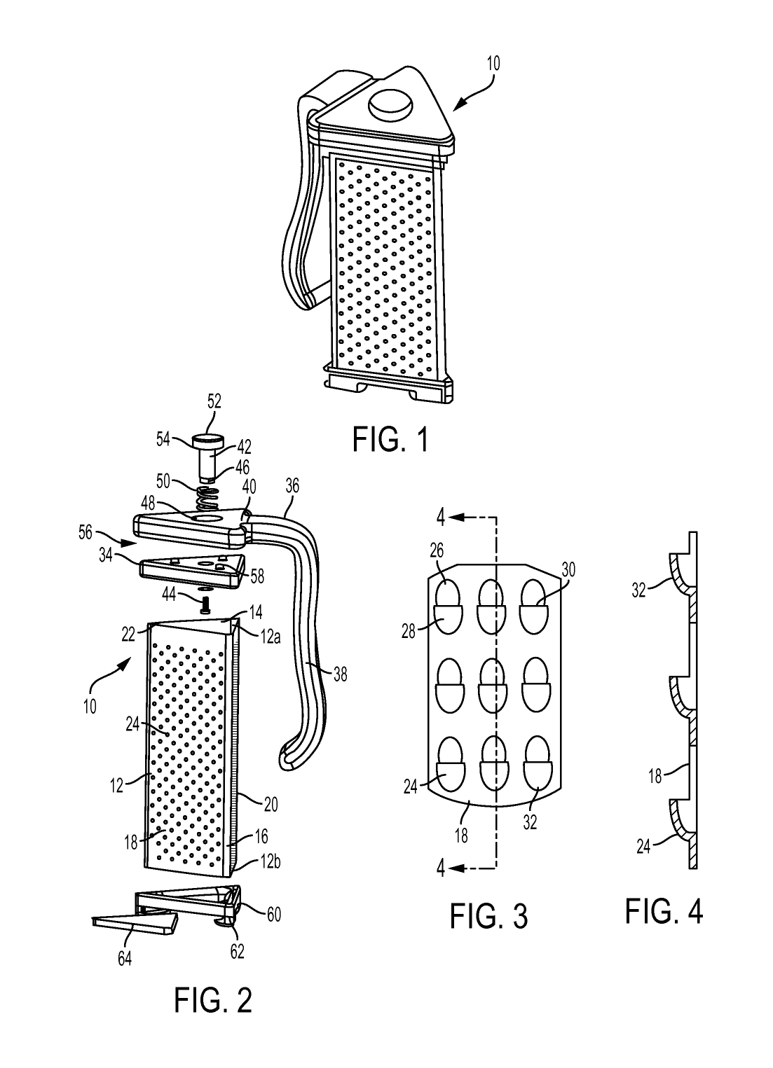

FIG. 1 shows an isometric view of an example embodiment of a grater 10 according to the invention. As shown in detail in the exploded view of FIG. 2, grater 10 comprises a body 12 surrounding a central space 14. In this example, body 12 comprises a tube 16 having a triangular cross-sectional shape. Body 12 comprises three grating surfaces 18, 20 and 22, the grating surfaces being substantially flat, although curved surfaces are also feasible.

Each grating surface 18, 20 and 22 has a plurality of grating features 24 that contact the foodstuff and effect the actual grating action. Example grating features 24 are shown on an enlarged scale, and in detail in FIGS. 3 and 4, and comprise a plurality of openings 26 in the grating surfaces 18, 20 and 22 that provide communication with the central space 14. To be considered a grating feature, a respective projection 28 is associated with each opening 26, the projection 28 affording an edge 30 that shears matter from the foodstuff being grated when the grater is applied to the foodstuff. The edge that shears matter from the foodstuff being grated may also be referred to as a “cutting edge.” The term “associated with” in this context means that the projections 28 are in proximity to the openings 26 such that matter sheared from the foodstuff is conducted through the openings and into the central space. As shown in FIGS. 3 and 4, the projections 28 take the form of a scoop 32 that projects from the grating surfaces. Other types of grating features are of course feasible and each grating surface 18, 20 and 22 may have a different grating feature 24 with characteristics that are tailored for different grating actions appropriate for different foodstuffs. The grating features may differ, for example, in size as well as shape to produce granules, shavings, slivers or shreds as required for a particular application on a particular foodstuff.

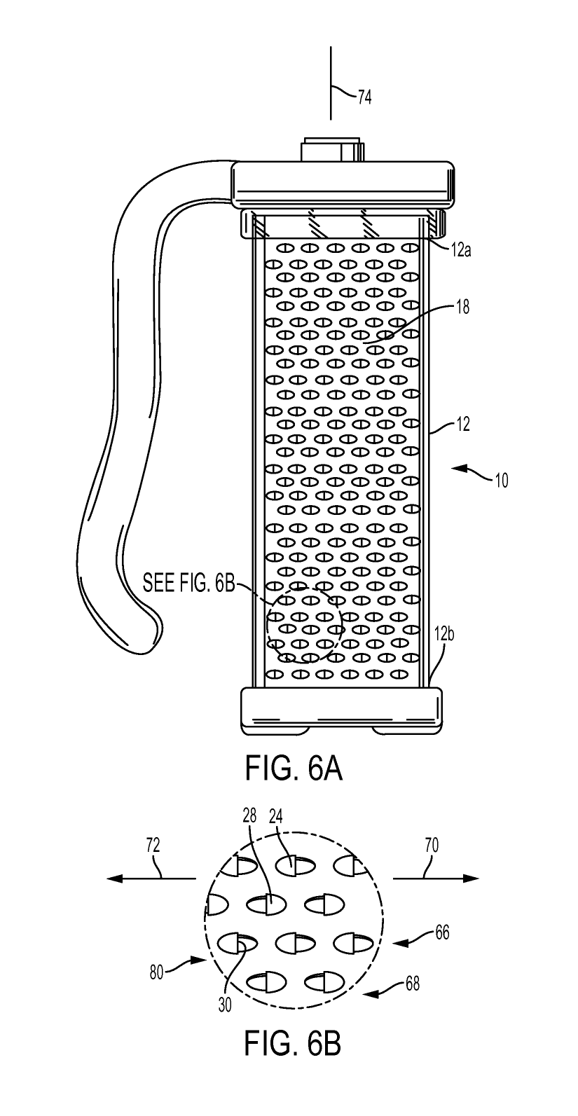

The respective projections of the grating features may be oriented relative to one another such that the cutting edges of the projections cut or shear towards different directions, thereby forming “multi-directional” grating features. This allows shearing of foodstuff when the grater is applied to foodstuff in varied directions. Example multi-directional grating features 24 are shown on an enlarged scale in the example grater 10 shown in FIG. 6. The grating surface 18 comprises a first plurality 66 of projections 28 of the grating features 24 each having a cutting edge 30 facing a first direction 70, and a second plurality 68 of the projections 28 each having a cutting edge 30 facing a second direction 72, wherein the second direction 72 is different from the first direction 70. The first direction 70 may be opposite to the second direction 72, as shown in the example of FIG. 6. The cutting edges 30 are advantageously positioned to face in opposite directions to allow shearing when the grater is applied to foodstuff with a pushing motion, as well as when the grater is applied with a pulling motion.

The multi-directional grating features 24 may also be oriented angularly with respect to a longitudinal axis 74 of the grater. Example grater 10, shown in FIG. 6, comprises a body 12 having a first end 12a and a second end 12b oppositely disposed from the first end 12a. The body 12 has a longitudinal axis 74 extending from the first end 12a to the second end 12b. The first plurality 66 of projections 28, each having a cutting edge 30 facing a first direction 70, may be oriented such that the first direction 70 is transverse to the longitudinal axis 74. The first direction 70 may be perpendicular to the longitudinal axis 74, as shown in the example of FIG. 6. Likewise, the second plurality 68 of projections 28, each having a cutting edge 30 facing a second direction 72, may be oriented such that the second direction 72 is transverse to the longitudinal axis 74. The second direction 72 may be perpendicular to the longitudinal axis 74. Example grater 10, shown in FIG. 6, comprises a first plurality 66 of projections 28 each having a cutting edge 30 facing a first direction 70, and a second plurality 68 of projections 28 each having a cutting edge 30 facing a second direction 72, wherein the first direction 70 and second direction 72 are transverse to the longitudinal axis 74. As shown in FIG. 6, the first direction 70 and second direction 72 are also perpendicular to the longitudinal axis 74.

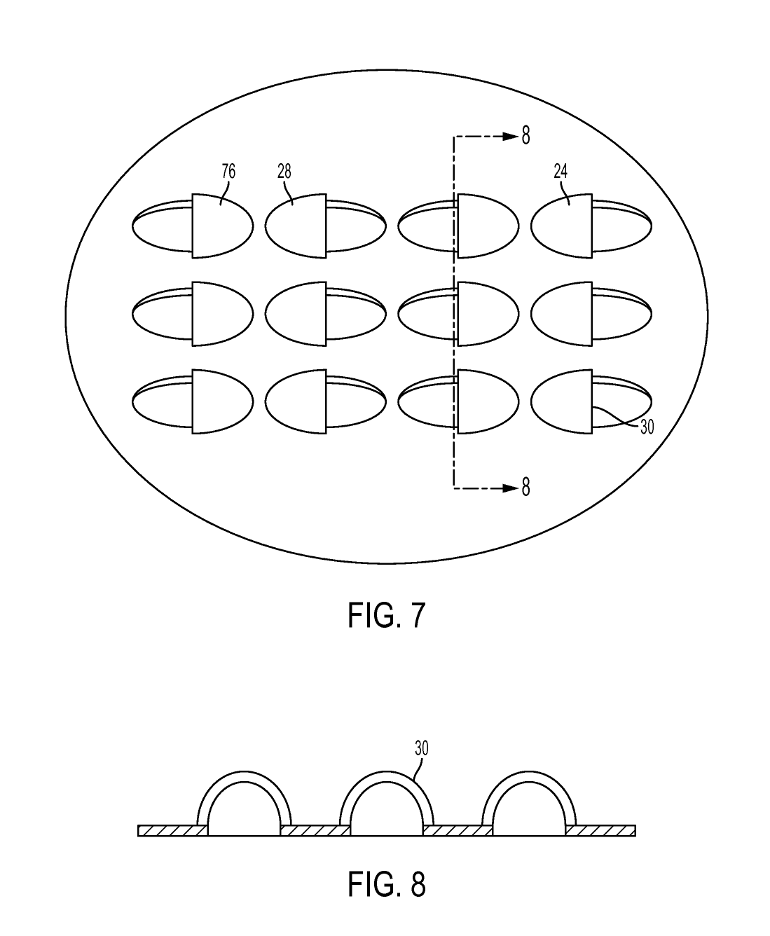

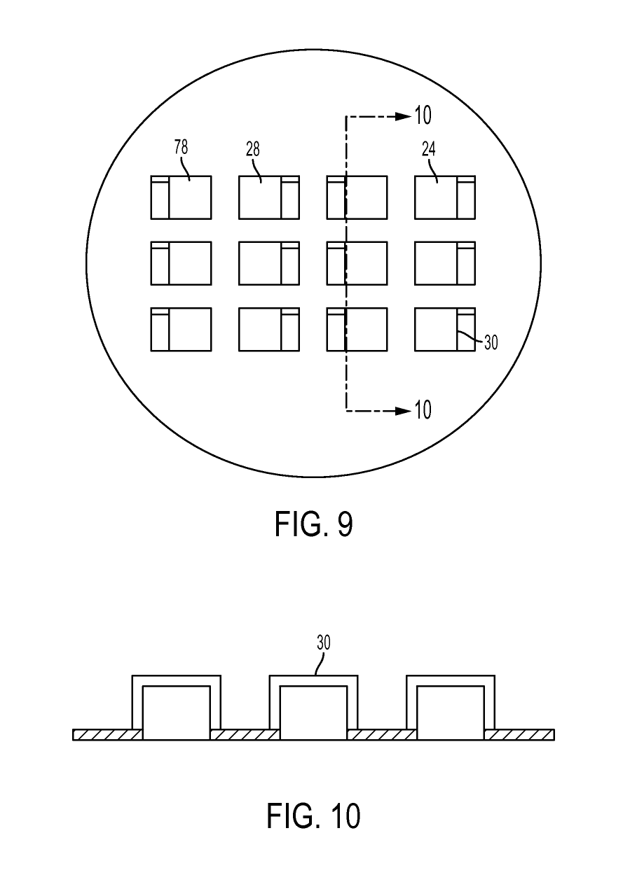

Various shapes of the cutting edge 30 are possible. For example, FIGS. 7 and 8 show example grating features 24, wherein the cutting edge 30 is curved. FIGS. 9 and 10 show example grating features 24, wherein the cutting edge 30 is substantially straight. Various shapes of the projections 28 are also possible. As shown in FIGS. 7 and 8, the projections 28 of the grating features 24 may have a rounded or curved surface 76 so that the projection 28 takes the form of a scoop. The projections 28 of the grating features 24 may also have substantially flat surfaces 78 so that the projection 28 takes the shape of a box (see FIGS. 9 and 10).

Various configurations of the grating features 24 or projections 28 are possible. The positioning of the projections 28 relative to each other and relative to the longitudinal axis 74 of the grater 10 may be varied to achieve different patterns of projections 28 on the grating surface 18. The projections 28, for example, may be arranged in rows 80. The rows 80 may be substantially parallel. Further, the rows 80 may be transverse to the longitudinal axis 74 of the grater 10. Example grater 10, shown in FIG. 6, shows the projections 28 arranged in a plurality of substantially parallel rows 80. The rows 80 are substantially perpendicular to the longitudinal axis 74. The projections 28 may be further arranged to form alternating rows 80 of projections 28 having a cutting edge 30 facing a first direction 70 and projections 28 having a cutting edge 30 facing a second direction 72, where the second direction 72 is different from the first direction 70. Other configurations or patterns of projections are of course feasible. The configurations or patterns may be appropriately designed to control the degree of shearing of foodstuff when different types of grating motions are used in particular applications or on particular foodstuff

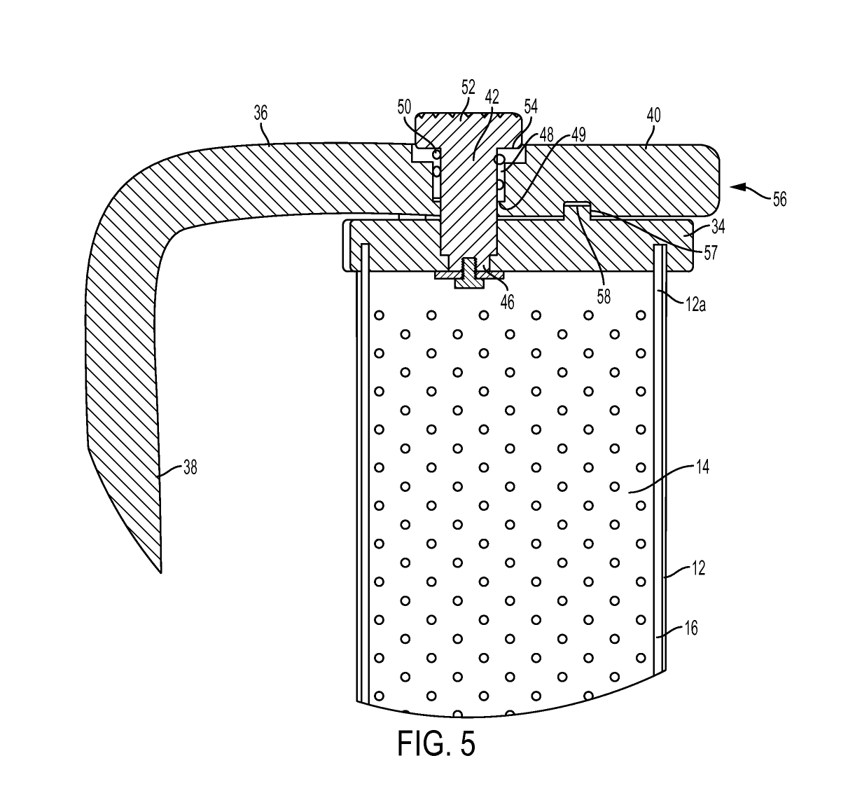

As further shown in FIGS. 2 and 5, a fitting 34 is attached to one end 12a of body 12. Fitting 34 is designed to close off the central space 14 at end 12a and permit a handle 36 to be attached to body 12. Handle 36 comprises a grip 38 attached to a head piece 40. Head piece 40 is rotatably attached to the fitting 34 to permit relative rotation between the handle 36 and body 12. In this example embodiment, relative rotation between the handle 36 and the body 12 is effected using a shaft 42. Shaft 42 is fixedly attached to the fitting 34 via a screw 44 and engages it with a square tang 46 so that shaft 42 cannot rotate relatively to the fitting 34. Shaft 42, otherwise, has a round cross section that passes through a hole 48 in head piece 40, permitting relative rotation between the shaft 42 and head piece 40, and hence between the handle 36 and the body 12. Hole 48 is countersunk to provide a surface 49 (see FIG. 5) extending into the hole which supports a spring 50 received within hole 48. In this example spring 50 comprises a coil spring, but other forms of spring are of course feasible. Shaft 42 is topped by an enlarged head 52 that retains the head piece 40 to the shaft 42 and provides a reaction surface 54 against which the spring 50 pushes. With spring 50 operating between the surface 49 extending into hole 48 and the surface 54 of head 52, the fitting 34 is drawn toward the head piece 40 by the biasing force of the spring.

To control relative rotation between the handle 36 and the body 12, a detent mechanism 56 is located between the fitting 34 and the head piece 40. In this example, the detent mechanism 56 comprises one or more posts 58 mounted on fitting 34 and projecting toward the head piece 40. Head piece 40 has one or more recesses 57 (See FIG. 5) facing the fitting 34 and positioned to receive posts 58. It is understood that the positions of the posts and recesses could be reversed, i.e., the posts could extend from the head piece 40 and the recesses could be positioned within the fitting 34. The detent mechanism either permits or prevents the relative rotation between the handle 36 and the body, as described below.

With reference again to FIG. 2, at a second end 12b of body 12 opposite first end 12a, a cap 60 is mounted to close off the second end. Cap 60 is openable to provide access to the central space 14, for example, to permit the dispensing of granules, shavings, slivers and the like that accumulate within the central space when the grater is used. In this example the cap comprises a frame 62 that receives and retains a plate 64 that is slidably movable into and out of the frame 62 to open and close end 12b of the body 12.

In operation, a user selects which grating surface 18, 20, 22 is to be used by depressing head 52 against its biasing spring 50. This causes fitting 34 to move away from head piece 40, thereby disengaging posts 58 from their respective recesses 57. This disengagement of the detent mechanism 56 permits the body 12 to turn relatively to handle 36. Body 12 and handle 36 are rotated relatively to one another to position a selected grating surface (18, 20 or 22) into a position relatively to handle 36, where it can be conveniently brought to bear against the foodstuff to be grated. Once the desired relative position between body and handle is established, the head 52 is released to permit the spring 50 to bias the fitting 34 back into engagement with the head piece 40. As the fitting 34 engages the head piece 40, the posts 58 engage the recesses 57, and the positive mechanical engagement between the posts and recesses prevents relative rotation between body 12 and handle 36. This provides a steady grating surface during forcible engagement between the grater and the foodstuff as the handle is gripped.

The body 12 is advantageously formed from stainless steel to provide sharp, stiff edges 30 that will not rust and will be easily cleaned. Parts such as the handle 36, fitting 34 and cap 60 may be advantageously made from plastic material, such as acrylonitrile butadiene styrene (ABS).

### EXEMPLARY EMBODIMENTS

In exemplary embodiments, disclosed herein is a grater. The grater comprises: a body surrounding a central space, the body having a first end, the body comprising at least one grating surface, the at least one grating surface comprising a plurality of openings communicating with the central space, at least a portion of the openings each having an associated projection extending outwardly from the grating surface away from the central space; a fitting mounted on and closing the first end of the body; a handle comprising a grip attached to a head piece, the head piece being rotatably attached to the fitting thereby permitting the body and the handle to rotate relatively to one another.

In one exemplary embodiment, the body further comprises a second end oppositely disposed from the first end; a cap mounted on and closing the second end of the body, the cap being openable to provide access to the central space.

In another exemplary embodiment, the body comprises three of the grating surfaces.

In another exemplary embodiment, the body has a triangular cross-sectional shape.

In another exemplary embodiment, at least one of the grating surfaces is substantially flat.

In another exemplary embodiment, the fitting has at least one post projecting therefrom toward the head piece; the head piece has at least one recess for receiving the at least one post, wherein engagement between the post and the recess inhibits relative rotation between the body and the handle.

In another exemplary embodiment, the head piece has at least one post projecting therefrom toward the fitting; the fitting has at least one recess for receiving the at least one post, wherein engagement between the post and the recess inhibits relative rotation between the body and the handle.

In another exemplary embodiment, the grater further comprises a spring operably engaged with the head piece and the fitting, the spring biasing the fitting into engagement with the head piece.

In another exemplary embodiment, the grater further comprises: a hole extending through the head piece, the hole receiving the spring, a surface extending into the hole and supporting the spring therein; a shaft extending through the hole, the shaft having a first end connected to the fitting and a second end attached to a head engaging the spring, the spring acting between the surface and the head to bias the fitting into the engagement with the head piece.

In another exemplary embodiment, the fitting has at least one post projecting therefrom toward the head piece; the head piece has at least one recess for receiving the at least one post, wherein engagement between the post and the recess inhibits relative rotation between the body and the handle.

In another exemplary embodiment, the head piece has at least one post projecting therefrom toward the fitting; the fitting has at least one recess for receiving the at least one post, wherein engagement between the post and the recess inhibits relative rotation between the body and the handle.

In another exemplary embodiment, the grater further comprises a first plurality of the projections each having a cutting edge facing a first direction, and a second plurality of the projections each having a cutting edge facing a second direction, wherein the second direction is different from the first direction.

In another exemplary embodiment, the first direction is opposite to the second direction.

In another exemplary embodiment, the body further comprises: a second end oppositely disposed from the first end; a longitudinal axis extending from the first end to the second end; and the first direction is transverse to the longitudinal axis.

In another exemplary embodiment, the second direction is transverse to the longitudinal axis.

In another exemplary embodiment, the first direction is perpendicular to the longitudinal axis.

In another exemplary embodiment, the second direction is perpendicular to the longitudinal axis.

In another exemplary embodiment, the first direction and the second direction are perpendicular to the longitudinal axis.

In another exemplary embodiment, the cutting edge is substantially straight.

In another exemplary embodiment, the cutting edge is curved.

In another exemplary embodiment, the projections are arranged in a plurality of substantially parallel rows.

In another exemplary embodiment, the rows are substantially perpendicular to the longitudinal axis.

In another exemplary embodiment, the arrangement of rows comprises alternating rows of the first plurality of the projections and the second plurality of the projections.

What is claimed is:

1. A grater, comprising:
a body surrounding a central space, said body having a first end, said body comprising at least one grating surface, said at least one grating surface comprising a plurality of openings communicating with said central space, at least a portion of said openings each having an associated projection extending outwardly from said grating surface away from said central space;
a fitting mounted on and closing said first end of said body;
a handle comprising a grip attached to a head piece, said head piece being rotatably attached to said fitting thereby permitting said body and said handle to rotate relatively to one another.

2. The grater according to claim 1, wherein:
said body further comprises a second end oppositely disposed from said first end;
a cap mounted on and closing said second end of said body, said cap being openable to provide access to said central space.

3. The grater according to claim 1, wherein said body comprises three of said grating surfaces.

4. The grater according to claim 3, wherein said body has a triangular cross sectional shape.

5. The grater according to claim 4, wherein at least one of said grating surfaces is substantially flat.

6. The grater according to claim 1, wherein:
said fitting has at least one post projecting therefrom toward said head piece;
said head piece has at least one recess for receiving said at least one post, wherein engagement between said post and said recess inhibits relative rotation between said body and said handle.

7. The grater according to claim 1, wherein:
said head piece has at least one post projecting therefrom toward said fitting;
said fitting has at least one recess for receiving said at least one post, wherein engagement between said post and said recess inhibits relative rotation between said body and said handle.

8. The grater according to claim 1, further comprising a spring operably engaged with said head piece and said fitting, said spring biasing said fitting into engagement with said head piece.

9. The grater according to claim 8, further comprising:
a hole extending through said head piece, said hole receiving said spring, a surface extending into said hole and supporting said spring therein;
a shaft extending through said hole, said shaft having a first end connected to said fitting and a second end attached to a head engaging said spring, said spring acting between said surface and said head to bias said fitting into said engagement with said head piece.

10. The grater according to claim 8, wherein:
said fitting has at least one post projecting therefrom toward said head piece;
said head piece has at least one recess for receiving said at least one post, wherein engagement between said post and said recess inhibits relative rotation between said body and said handle.

11. The grater according to claim 8, wherein:
said head piece has at least one post projecting therefrom toward said fitting;
said fitting has at least one recess for receiving said at least one post, wherein engagement between said post and said recess inhibits relative rotation between said body and said handle.

12. The grater according to claim 1, further comprising:
a first plurality of said projections each having a cutting edge facing a first direction, and a second plurality of said projections each having a cutting edge facing a second direction, wherein said second direction is different from said first direction.

13. The grater according to claim 12, wherein said first direction is opposite to said second direction.

14. The grater according to claim 12, wherein said body further comprises:
a second end oppositely disposed from said first end;
a longitudinal axis extending from said first end to said second end; and
said first direction is transverse to said longitudinal axis.

15. The grater according to claim 14, wherein said second direction is transverse to said longitudinal axis.

16. The grater according to claim 14, wherein said first direction is perpendicular to said longitudinal axis.

17. The grater according to claim 15, wherein said second direction is perpendicular to said longitudinal axis.

18. The grater according to claim 15, wherein said first direction and said second direction are perpendicular to said longitudinal axis.

19. The grater according to claim 12, wherein said cutting edge is substantially straight.

20. The grater according to claim 12, wherein said cutting edge is curved.

21. The grater according to claim 12, wherein said projections are arranged in a plurality of substantially parallel rows.

22. The grater according to claim 21, wherein said rows are substantially perpendicular to said longitudinal axis.

23. The grater according to claim 22, wherein the arrangement of rows comprises alternating rows of said first plurality of said projections and said second plurality of said projections.
